(19) United States
(12) Patent Application Publication
(10) Pub. No.: US 2024/0253059 A1
(43) Pub. Date: Aug. 1, 2024

(54) A METHOD OF OPERATING A CENTRIFUGAL SEPARATOR

(71) Applicant: Alfa Laval Corporate AB, LUND (SE)

(72) Inventors: Doncho BACHVAROV, SØBORG (DK); Yacine DJEDOU, HUDDINGE (SE)

(73) Assignee: Alfa Laval Corporate AB, LUND (SE)

(21) Appl. No.: 18/561,107

(22) PCT Filed: May 13, 2022
(86) PCT No.: PCT/EP2022/063061

§ 371 Date: Nov. 15, 2023

(30) Foreign Application Priority Data
Jun. 7, 2021 (EP) 21178021.8

(51) Int. Cl. B04B 1/14; B04B 15/08

(52) U.S. Cl. CPC B04B 1/14; B04B 15/08

(57) ABSTRACT

In a method of operating a centrifugal separator, the centrifugal separator includes a centrifuge bowl arranged to rotate around an axis of rotation and in which the separation of a liquid mixture takes place; a stationary frame which defines a surrounding space in which the centrifuge bowl is arranged; and a drive member configured to rotate the centrifuge bowl in relation to the frame around the axis of rotation. The centrifuge bowl includes an inlet for receiving the liquid mixture to be separated, at least one liquid outlet for discharging a separated liquid phase and an intermittent discharge system for discharging a separated sludge phase from the centrifuge bowl. The method includes supplying a liquid feed mixture to be separated to the inlet of the centrifuge bowl; separating the liquid feed mixture into at least one separated liquid phase and a separated sludge phase; and supplying hydraulic fluid to the intermittent discharge system to initiate discharge of a separated sludge phase from the centrifuge bowl. The amount of supplied hydraulic fluid is determined by the magnitude of a generated trigger signal Tgen and the magnitude of the generated trigger signal Tgen is dependent on the air pressure around the centrifuge bowl.

### FIELD OF THE INVENTION

The present invention relates to the field of centrifugal separators, and more specifically to a method of operating a centrifugal separator for separating a liquid mixture into at sludge phase and at least one liquid phase.

### BACKGROUND OF THE INVENTION

Centrifugal separators are generally used for separation of liquids and/or for separation of solids from a liquid. During operation, liquid mixture to be separated is introduced into a rotating bowl and heavy particles or denser liquid, usually water, accumulates at the periphery of the rotating bowl whereas less dense liquid accumulates closer to the central axis of rotation. This allows for collection of the separated fractions, e.g. by means of different outlets arranged at the periphery and close to the rotational axis, respectively.

In certain types of centrifugal separators, separated sludge is discharged through a number of ports in the periphery of the separator bowl. Between discharges these ports are covered by e.g. an operating slide, which forms an internal bottom in the separating space of the bowl. Such an operating slide may be pressed up against the upper part of the bowl to cover the ports by the force of a hydraulic fluid, such as water, underneath. In order to initiate a sludge discharge, the hydraulic fluid is drained from underneath the operating slide so that the lifting force acting to press the operating slide upwards is decreased, which in turn initiates a motion of the operating slide so that the ports are opened. To close the ports again, hydraulic fluid is yet again supplied to the space underneath the operating slide. Such hydraulically operated systems allows for opening and closing of the ports for only a fraction of a second and may result in partial or complete emptying of the content in the separation bowl.

Further, in order to overcome problems with high energy consumption of the centrifugal separator during operation, it is known e.g. from WO10101524 to create a sub-atmospheric pressure around the rotating centrifuge bowl during operation. The removal of gas due to the creation of the sub-atmospheric pressure reduces friction losses during operation.

However, reducing the pressure around the rotating centrifuge bowl may significantly affect the volume of the discharged sludge and lead to inconsistent discharge sizes, from very small to very large discharge sizes, which may cause interruptions in the separation process.

Thus, there is a need in the art for improved methods of operating a centrifugal separator, especially in sub-atmospheric pressure.

### SUMMARY OF THE INVENTION

It is an object of the invention to at least partly overcome one or more limitations of the prior art. In particular, it is an object to provide a method of operating a centrifugal separator that lead to more consistent discharge sizes at a negative pressure around the rotating centrifuge bowl.

As a first aspect of the invention, there is provided a method of operating a centrifugal separator, wherein the centrifugal separator comprises
a centrifuge bowl arranged to rotate around an axis of rotation (X) and in which the separation of a liquid mixture takes place,
a stationary frame which defines a surrounding space in which said centrifuge bowl is arranged,
a drive member configured to rotate the centrifuge bowl in relation to the frame around the axis of rotation (X), wherein the centrifuge bowl further comprises an inlet for receiving the liquid mixture to be separated, at least one liquid outlet for discharging a separated liquid phase and an intermittent discharge system for discharging a separated sludge phase from the centrifuge bowl,
wherein the method comprises the steps of
a) supplying a liquid feed mixture to be separated to the inlet of the centrifuge bowl,
b) separating the liquid feed mixture into at least one separated liquid phase and a separated sludge phase,
c) supplying hydraulic fluid to the intermittent discharge system to initiate discharge of a separated sludge phase from the centrifuge bowl, wherein the amount of supplied hydraulic fluid is determined by the magnitude of a generated trigger signal T_{gen} and further wherein the magnitude of the generated trigger signal T_{gen} is dependent on the air pressure around the centrifuge bowl.

The centrifugal separator may be a disc-stack centrifugal separator, e.g. as disclosed in US20210107014. The stationary frame delimits a surrounding space, which thus may be sealed relative the surroundings of the frame, and in which said centrifuge bowl is arranged. The space may be sealed relative the surroundings by means of e.g. mechanical seals or liquid seals.

Step a) of supplying a liquid feed mixture to the centrifuge bowl may be performed by supplying the feed mixture via a stationary inlet pipe extending into the centrifuge bowl from the top, or via a rotating, hollow spindle onto which the centrifuge bowl is attached, such as via a hollow spindle attached to the bottom of the centrifuge bowl. Step a) may be performed while the centrifuge bowl is rotating.

Step b) of separating takes place within the centrifuge bowl, such as in a stack of separation discs arranged in the centrifuge bowl.

The centrifugal separator is arranged for discharging a sludge phase, i.e. a separated sludge phase that may also contain some liquid, to the surrounding space around the centrifuge bowl. This is performed by an intermittent discharge system comprising sludge outlets at the periphery of the centrifuge bowl. The sludge outlets may be in the form of a set of ports arranged to be opened intermittently during operation. The centrifugal separator may be arranged for emptying a partial content of the bowl during such an intermittent discharge (partial discharge) or arranged for emptying the whole content of the centrifuge bowl during intermittent discharge (full discharge).

The intermittent discharge system thus controls the opening of the sludge outlets. For this purpose, the intermittent discharge system may comprise a an operating slide that is movable between a closed position, in which the sludge outlets are closed, and an open position, in which the sludge outlets are open. Keeping the operating slide in a closed position may be effected by supplying hydraulic fluid via a channel to a closing chamber between the operating slide and the frame in order to hold the operating slide in the closed position. The intermittent discharge system may further comprise an opening chamber, to which hydraulic fluid is supplied when to change the operating slide to its open position. The intermittent discharge system may thus comprise sludge outlets and an operating slide arranged within the centrifuge bowl to open and close the sludge outlets.

The amount of hydraulic fluid, such as water, being supplied to the intermittent discharge system is determined by the magnitude of a trigger signal T_{gen}. The first aspect of the invention is based on the insight that the discharge volume may be adjusted dynamically during operation of the centrifugal separator by taking the magnitude of the pressure around the centrifuge bowl into account when discharging a sludge phase. As a result, the magnitude of the trigger signal T_{gen} for discharge is continuously adjusted and can e.g. be made proportional to the air pressure around the centrifuge bowl, thereby maintaining the volume of discharge within an acceptable interval. The air pressure around the centrifuge bowl is the air pressure in the volume in which the centrifuge bowl rotates during operation, such as the surrounding space delimited by the frame.

A high magnitude of the generated trigger signal T_{gen} may lead to high amount of hydraulic fluid being supplied, which in turn may lead to a long opening time for the sludge outlets. The hydraulic fluid may thus be operating water.

Thus, the amount of hydraulic fluid being supplied to the intermittent discharge system determines the time during which the sludge outlets are opened. Consequently, step c) may further actually comprise discharging the separated sludge phase based on the generated trigger signal T_{gen}.

A lower air pressure around the centrifuge bowl would generally lead to a larger volume being discharged, so the inventors have found that the generated trigger signal T_{gen} have to be lower with a lower air pressure, i.e. with a larger negative pressure, around the centrifuge bowl.

In embodiments of the first aspect, the method further comprises removing gas from the surrounding space to obtain a negative pressure in the surrounding space.

This may be performed e.g. before step a) of supplying liquid feed mixture to the inlet. The step of removing gas may be performed before or during rotation of the centrifuge bowl, e.g. by means of a vacuum pump which is connected to the surrounding space, either directly or indirectly. This thus gives a sub-atmospheric pressure in the space in the frame surrounding the centrifuge bowl.

In embodiments of the first aspect, the method further comprises measuring the air pressure around the centrifuge bowl and using the measured air pressure for determining the magnitude of the generated trigger signal T_{gen}.

The air pressure may be measured continuously or at discrete time points, such as just before or during step c) is performed.

Step c) of initiating discharge of a separated solids phase may be performed at certain time points during the separation process. Thus, step c) may be repeated several times during a separation process, depending on the amount of sludge in the liquid feed mixture. During separation, at least one, such as one or two, liquid phases are separated from the liquid feed mixture. Consequently, the method may further comprise discharging at least one separated liquid phase from the centrifuge bowl. Discharge of at least one liquid phase may be performed continuously.

In embodiments of the first aspect, the generated trigger signal T_{gen} is a pneumatic signal. Thus, the generated trigger signal T_{gen} may be in the form of a pulse of air pressure supplied to the intermittent discharge system. The magnitude of T_{gen} may thus correspond to the absolute pressure of the air pressure.

In embodiments of the first aspect, the hydraulic fluid in step c) is water that is supplied to the intermittent discharge system by an operating water module (OWM).

The OWM may thus be connected to the intermittent discharge system and be arranged to supply an amount of water to the intermittent discharge system based on the magnitude of the generated trigger signal T_{gen}, such as to the magnitude of the pulse of air being supplied to the OWM. Thus, step c) may comprise sending a generated trigger signal T_{gen}, such as a generated pneumatic signal, to an OWM. The OWM then sends and amount of water to the intermittent discharge system to open the sludge outlets, wherein the amount of water is based on the magnitude of the generated trigger signal T_{gen}. As an example, different magnitudes of T_{gen} may correspond to different pressures of the air pressure pulse being sent to the OWM. As result, the air volume send to the OWM is different. Larger air volume leads to larges hydraulic liquid volume being supplied, and longer opening time of the sludge outlets of the centrifugal bowl.

In embodiments of the first aspect, the magnitude of the generated trigger signal T_{gen} is generated by performing the steps of
d1) generating an initial trigger signal Tᵢₙ;
d2) receiving a measured negative air pressure P1 from the space surrounding the centrifuge bowl;
d3) converting the measured air pressure P1 into a compensation factor C1 using an equation C(P) of the compensation factor C as a function of the negative air pressure around the centrifuge bowl;
d4) adjusting the magnitude of the initial trigger signal Tᵢₙ with the compensation factor C1 to generate the magnitude of the generated trigger signal T_{gen}.

As an example, the magnitude of the initial trigger signal Tᵢₙ may be defined by the specific separation process or an operator before operation of the centrifugal separator. Thus, the initial value of the trigger signal, i.e. Tᵢₙ, may be set based on the type of separation process, i.e. the amount of sludge etc. within the feed. This may be set manually by an operator based on empirical studies on the amount of sludge being discharged for a specific process at a specific air pressure around the centrifuge bowl.

This initial trigger signal Tᵢₙ is thus then converted or adjusted based on information from the actual air pressure around the centrifuge bowl. As discussed above, the actual air pressure, such as the negative air pressure P1, may be measured just before initiating the discharge of step c) and thus just before generating the magnitude of the generated trigger signal T_{gen}. The adjustment of the initial trigger signal Tᵢₙ is performed by calculating a compensation factor C1, which is then used to adjust or scale the magnitude of the initial trigger signal Tᵢₙ. The compensation factor C1 is calculated from P1 using a relationship between measured magnitude of negative air pressure and compensation factor, i.e. a function of C(P). As an example, this equation or function C(P) may be a straight-line equation.

The straight-line equation may be determined a calibration procedure using the maximum pressure compensation factor Cₘₐₓ at the lowest possible air pressure Pₘₐₓ, wherein Cₘₐₓ=C(Pₘₐₓ).

Thus, C(P) may be determined by determining the maximum compensation factor Cₘₐₓ used when there is the highest negative pressure around the centrifuge bowl during operation, Pₘₐₓ. At zero negative pressure P₀, i.e. at atmospheric pressure, the compensation factor may be set to zero, meaning that C(P₀)=0. Consequently, using the relationship C(P₀)=0 and C(Pₘₐₓ)=Cₘₐₓ, a straight calibration curve relating the air pressure around the centrifuge bowl to a compensation factor may be determined.

Cₘₐₓ may also be determined using empirical studies.

As a further example, the magnitude of the generated trigger signal T_{gen} may be defined as the percentage or fraction of a maximum generated trigger signal Tₘₐₓ.

This may be an advantage since unit conversion may be avoided. As an example, the T_{gen} may be set as a percentage of fraction of the range of an I/P converter used to set the actual generated trigger signal. The generated trigger signal T_{gen} may be a pressure signal sent to an OWM, as discussed above. The pressure range may for example be between 0-600 kPa, meaning that Tₘₐₓ is 600 kPa, and T_{gen} may thus be defined as the percentage or fraction of 600 kPa.

Also the initial trigger signal Tᵢₙ may be expressed as the percentage or fraction of a maximum generated trigger signal Tₘₐₓ.

In embodiments of the first aspect, the generated trigger signal is further dependent on the rotational speed of the centrifuge bowl and/or the flow rate of liquid feed mixture.

Thus, also the actual rotational speed may be taken into account when generating the trigger signal T_{gen}. A lower rotational speed may lead to larger volume being discharged through the sludge outlet. This is because a reduced bowl speed may lead to a reduced turning speed of a paring device of the intermittent discharge system used for supplying operating water. Lower speed of such paring device result in lower pressure of any closing liquid supplied for closing the sludge outlets, and thus longer time for closing the sludge outlets.

Further, as an alternative or a complement, the flowrate of liquid feed mixture may also be taken into account when generating T_{gen}. A higher flow may lead to a larger volume being discharged from the sludge outlets.

Further, in embodiments of the first aspect, the method comprises measuring the flow rate of liquid feed mixture and/or measuring the speed of the rotational bowl.

Consequently, step d2) as defined above may comprise receiving a measured flow rate F1 of the liquid feed mixture and/or receiving a measured rotational bowl speed S1. In analogy, step d3) may comprise converting the measured flow rate F1 into a compensation factor C2 using an equation C(F) of the compensation factor C as a function of the flow rate of the liquid feed mixture and/or converting the measured speed of the rotational bowl S1 into a compensation factor C3 using an equation C(S) of the compensation factor C as a function of the speed of the rotational bowl.

Thus, step d4) may then comprise adjusting the magnitude of the initial trigger signal Tᵢₙ with the compensation factor C1 and C2 and/or C3 to generate the magnitude of the generated trigger signal T_{gen}. Thus, Tᵢₙ may be compensated with C1 only, with C1 and C2, with C1 and C3, or with C1, C2 and C3.

The method may further comprise supplying hydraulic fluid to the centrifugal bowl for closing the sludge outlets again, as known in the art.

As a second aspect of the invention, there is provided a centrifugal separator for separating at least one liquid phase and a sludge phase from a liquid feed mixture, comprising
a centrifuge bowl arranged to rotate around an axis of rotation (X) and in which the separation of the liquid mixture takes place,
a stationary frame which defines a surrounding space in which said centrifuge bowl is arranged,
a drive member configured to rotate the centrifuge bowl in relation to the frame around the axis of rotation (X), wherein the centrifuge bowl further comprises an inlet for receiving the liquid mixture to be separated, at least one liquid outlet for discharging a separated liquid phase,
an intermittent discharge system for discharging a separated sludge phase from the centrifuge bowl,
a supply system for supplying hydraulic fluid to the intermittent discharge system, wherein the amount of supplied hydraulic fluid is determined by the magnitude of a generated trigger signal T_{gen},
a control unit configured to generate said trigger signal T_{gen} dependent on the air pressure around the centrifuge bowl and to send said generated trigger signal T_{gen} to said supply system.

This aspect may generally present the same or corresponding advantages as the former aspect. Effects and features of this second aspect are largely analogous to those described above in connection with the first aspect. Embodiments mentioned in relation to the first aspect are largely compatible with the second aspect.

The centrifugal separator may be operated according to the method of the first aspect. The centrifugal separator is for separation of a liquid feed mixture. The liquid feed mixture may be an aqueous liquid or an oily liquid. As an example, the centrifugal separator may be for separating solids and one or two liquids from the liquid feed mixture.

The stationary frame of the centrifugal separator is a non-rotating part. The centrifuge bowl of the separator may be arranged to be rotated around vertical axis of rotation, i.e. the axis of rotation (X) may extend vertically. The centrifuge bowl is usually supported by a spindle, i.e. a rotating shaft, and may thus be mounted to rotate with the spindle. Consequently, the centrifugal separator may comprise a spindle that is rotatable around the axis of rotation (X). The centrifugal separator may be arranged such that the centrifuge bowl is supported by the spindle at one of its ends, such at the bottom end or the top end of the spindle.

The drive member may comprise an electrical motor having a rotor and a stator. The rotor may be fixedly connected to a rotating part, such as to a spindle. Advantageously, the rotor of the electrical motor may be provided on or fixed to the spindle of the rotating part. Alternatively, the drive member may be provided beside the spindle and rotate the rotating part by a suitable transmission, such as a belt or a gear transmission.

The centrifuge bowl encloses by rotor walls a separation space. The separation space, in which the separation of the fluid mixture takes place may comprise separation members, such as a stack of separation discs. The separation discs may e.g. be of metal. Further, the separation discs may be frustoconical separation discs, i.e. having separation surfaces forming frustoconical portions of the separation discs. The separation discs may be arranged coaxially around the axis of rotation (X) at a distance from each other such that to form passages between each two adjacent separation discs.

As used herein, the term “axially” denotes a direction which is parallel to the rotational axis (X). Accordingly, relative terms such as “above”, “upper”, “top”, “below”, “lower”, and “bottom” refer to relative positions along the rotational axis (X). Correspondingly, the term “radially” denotes a direction extending radially from the rotational axis (X). A “radially inner position” thus refers to a position closer to the rotational axis (X) compared to “a radially outer position”.

The centrifugal separator also comprises an inlet for liquid mixture to be separated (the liquid feed mixture). This inlet may be arranged for receiving the liquid feed mixture and be arranged centrally in the centrifuge bowl, thus at rotational axis (X). The centrifuge bowl may be arranged to be fed from the bottom, such as through a spindle, so that the liquid feed mixture is delivered to the inlet from the bottom of the separator. However, the centrifuge bowl may also be arranged to be fed from the top, such as through a stationary inlet pipe extending into the bowl.

Further, also one or two liquid outlets may be arranged at the top or the bottom of the centrifugal separator and a sludge outlet.

The intermittent discharge system may comprise the sludge outlets. Further, the intermittent discharge system may comprise an operating slide used for opening and closing the sludge outlets, as known in the art.

The sludge outlet may thus be in the form of a set of intermittently openable outlets. The centrifuge bowl may therefore comprise at its outer periphery a set of radially sludge outlets in the form of intermittently openable outlets. The intermittently openable outlets may be equidistantly spaced around the axis of rotation (X).

The supply system may be arranged for supplying e.g. water to an opening chamber for moving an operating slide. Thus in embodiments of the second aspect, the supply system is an operating water module (OWM) arranged for supplying water to the intermittent discharge system.

The control unit may comprise any suitable type of programmable logical circuit, processor circuit, or microcomputer, e.g. a circuit for digital signal processing (digital signal processor, DSP), a Central Processing Unit (CPU), a processing unit, a processing circuit, a processor, an Application Specific Integrated Circuit (ASIC), a microprocessor, or other processing logic that may interpret and execute instructions. Thus, the control unit may comprise a processor and an input/output interface for communicating with the supply system, such as an OWM, and for receiving information about a measured air pressure around the centrifuge bowl.

In embodiments of the second aspect, the centrifugal separator further comprises a pump device arranged for removing gas to obtain sub-atmospheric pressure in said surrounding space.

The pump device is for removing gas in the surrounding space.

The pump device may comprise a liquid ring pump, a lamella pump, an ejector pump, a membrane pump, a piston pump, a scroll pump, a screw pump or combinations thereof. The pump device may further be a vacuum source or negative pressure source. A liquid ring pump prefilled with water is suitable for pumping of gas mixed with water. As an alternative, a lamella pump may be used for reaching pressures below the prevailing vapour pressure for water. An ejector pump further makes it possible to use existing liquid flows in the system, e.g. the flow of said fluid for centrifugal separation at an inlet or outlet, as a way of generating said negative pressure.

According to an embodiment of the invention, the pump device is arranged for removing both gas and liquid material from the space around the rotor, which liquid material may comprise medium supplied to the space, sludge phase discharged to the space from the separation space, condensate, cleaning agents or combinations thereof.

The pump device may be arranged to remove medium, e.g. gas and/or liquid, from the surrounding space around the centrifuge bowl either continuously or intermittently.

A pressure lower than atmospheric pressure may be a pressure of 1-50 kPa, preferably 2-10 kPa. The pump device may further be arranged to adjust the pressure in the space during operation on the basis of some operating condition of the centrifugal separator.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1 shows a schematic drawing of a centrifugal separator according to an embodiment of the present invention.

FIG. 2 shows a schematic drawing of a centrifuge bowl according to an embodiment of the present invention.

FIG. 3 shows a flow chart of a method of operating a centrifugal separator.

FIG. 4 shows a flow chart of a method of generating a trigger signal T_{gen}.

FIGS. 5a-c show how a measured pressure, flow rate and rotational speed may be converted into compensation factors C1, C2 and C3.

### DETAILED DESCRIPTION

The method and the centrifugal separator according to the present disclosure will be further illustrated by the following description with reference to the accompanying drawings.

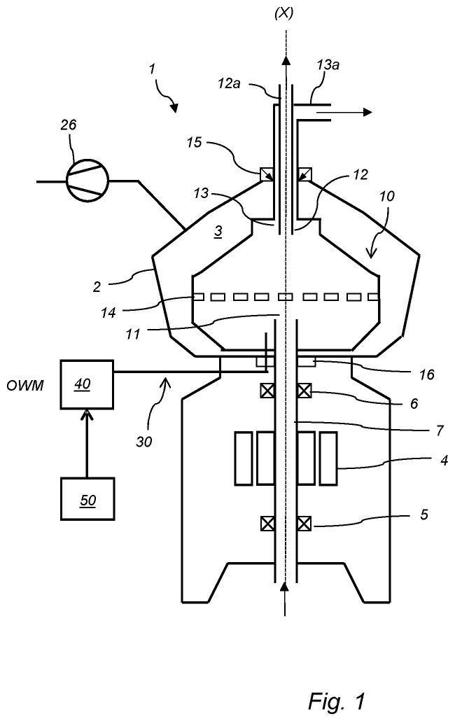

FIG. 1 show a cross-section of an embodiment of a centrifugal separator 1 arranged to separate a sludge phase, a liquid heavy phase and a liquid light phase from a liquid feed mixture.

The centrifugal separator 1 comprises a centrifuge bowl 10 which is arranged to rotate around an axis of rotation (X) by means of a spindle 7. The spindle 7 is supported in a stationary frame 2 in a bottom bearing 5 and a top bearing 6. The centrifuge bowl 10 is attached the upper portion of the spindle 7 and forms within itself a separation chamber in which centrifugal separation of the liquid feed mixture takes place during operation.

The spindle 7 is in this example a hollow spindle for introducing the liquid feed mixture to the inlet 11 of the centrifuge bowl 10. The centrifuge bowl 10 further comprises a liquid outlet 12 for discharging a separated liquid light phase and a liquid outlet 13 for discharging a liquid heavy phase. The liquid light phase outlet 12 is arranged at a smaller radius than the liquid heavy phase outlet 13. There is further a stationary outlet pipe 12a connected to the liquid light phase outlet 12 for receiving the separated liquid light phase, and a stationary outlet pipe 13a connected to the liquid heavy phase outlet 13 for receiving the separated liquid heavy phase.

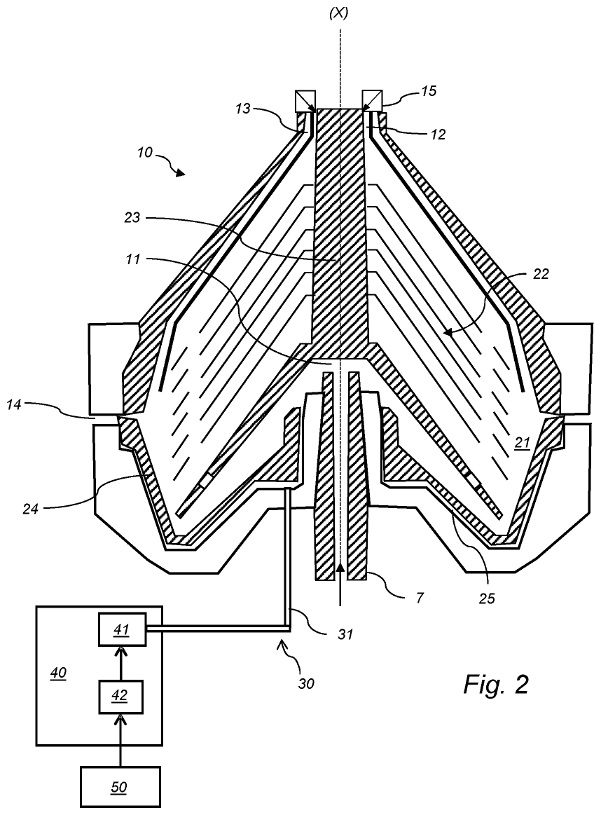

The centrifuge bowl 10 further comprises a sludge outlet 14 for discharging a separated sludge phase to the surrounding space 3, which is sealed relative the surroundings of the frame 2 and in which the centrifuge bowl 10 is arranged. The sludge outlet 14 takes the form of a set of intermittently openable sludge outlets arranged at the outer periphery of the centrifuge bowl 10, for discharge of sludge from a radially outer portion of the separation space to the surrounding space 3. The sludge outlets may form part of the intermittent discharge system 30, which also comprises an axially movable operating slide 21 arranged in the centrifuge bowl 10 and further shown in FIG. 2.

The centrifugal separator 1 further comprises a drive motor 4 configured to rotate the centrifuge bowl 10 in relation to the frame 2 around the axis of rotation (X). The drive motor 4 is connected directly to the spindle 7. However, the drive motor may also be connected to the spindle 7 via a transmission means in the form of a worm gear which comprises a pinion and an element connected to the spindle in order to receive driving torque. The transmission means may alternatively take the form of a propeller shaft, drive belts or the like.

The surrounding space 3 is sealed relative the surroundings of the frame by means of an upper seal 15 and a lower seal 16. The frame 3 thus delimits a space 3 which contains the centrifuge bowl 10 and which is air-tightly sealed relative to the surroundings of the frame. The upper seal 15 may be an outlet seal that seals the liquid outlets from the surroundings. If thee centrifugal separator is arranged with a stationery inlet pie extending into the centrifuge bowl from the top, the upper seal 15 could also be the seal that seal the inlet from the surroundings.

The upper seal 15 could for example be a mechanical seal or a liquid seal. Further, the upper seal 15 may be a gas seal, a liquid seal, a labyrinth seal or combinations thereof. Also the lower seal 16 could be a mechanical seal or a liquid seal. Further, the lower seal 16 may be a gas seal, a liquid seal, a labyrinth seal or combinations thereof.

One or both of the upper 15 and lower seal 16 could be a hermetic seal.

The centrifugal separator is further provided with a pump device 26 for removal of gas from the surrounding space 3, which pump device 26 takes the form of a water-filled liquid ring pump or, as an alternative, a lamella pump. The pump device is in this example connected directly to the frame 3 but could as an example also be connected to the vessel 20 discussed below.

FIG. 2 further shows the interior of the centrifuge bowl 10. The separation space 21 within the centrifuge bowl 10 is provided with a stack 22 of frustoconical separation discs in order to achieve effective separation of the liquid feed mixture. The stack 22 is arranged on distributor 23 which guides the liquid feed mixture from the inlet 11 to the separation space 21.

The opening of the sludge outlets 14 of the intermittent discharge system 30 is controlled by means of an operating slide 24 actuated by operating water in channel 25, as known in the art. In its position shown in the drawing, the operating slide 24, also called a sliding bowl bottom, abuts sealingly at its periphery against the upper part of the centrifuge bowl 10, thereby closing the separation space 21 from connection with outlets 14, which are extending through the centrifuge bowl 10.

The operating slide 24 is movable between a closed position, shown in FIG. 2, in which the sludge outlets 14 are closed, and an open position, in which sludge outlets 14 are open.

A closing chamber (not shown) is provided between below the operating slide 24. During operation, the closing chamber may contain hydraulic fluid, such as water, acting on the operating slide 24 to close the outlets 14. The draining of the hydraulic fluid from the closing chamber, and thereby opening of the sludge outlets 14, is initiated by introducing hydraulic fluid, such as water, to duct 25 via pipes 31 from a supply system 40 in the form of an operating water module (OWM).

Supply of water into duct 25 starts the opening of drainage nozzles for drainage of the hydraulic fluid from the closing chamber. This will in turn cause the operating slide 24 to move to a lower position so that sludge is discharged through sludge outlets 14. When the hydraulic fluid has been drained from the closing chamber, the operating slide 24 is again moved to an upper position to close the sludge outlets 14. The supply of hydraulic fluid to duct 25 may be aided by a paring disc (not shown) arranged in a paring chamber arranged axially below the centrifuge bowl 10. As an example, lower seal 16 may be a liquid seal arranged in such paring chamber.

The OWM 40 comprises a compressed air unit 42 which in turn forces a piston 41 in the OWM 27 to push water from the OWM 27 to the intermittent discharge system 30, more precisely to duct 25 via pipes 31 of the intermittent discharge system 30. The intermittent discharge system 30 may also comprise a paring device used for supplying hydraulic fluid in pipes 31 into the rotating bowl 10.

In this example, the compressed air unit 42 generates a trigger signal T_{gen} in the form of a pulse of compressed air. The magnitude of T_{gen}, i.e. the magnitude or setpoint of the compressed air from the compressed air unit 42, is generated by control unit 50. The magnitude of T_{gen} thus gives rise to different amounts of water being pushed from the OWM 40. A high magnitude of T_{gen} may thus lead to a larger amount of water being pushed from the OWM, and consequently a longer time period during which the sludge outlets 14 are open, as compared to a low magnitude of T_{gen}. Thus, the OWM 40 represents a supply system 40 for supplying hydraulic fluid to the intermittent discharge system 30, wherein the amount of supplied hydraulic fluid is determined by the magnitude of the generated trigger signal T_{gen},

In order to generate the magnitude of T_{gen}, the control unit 50 may for example comprise a calculation unit which may take the form of substantially any suitable type of programmable logical circuit, processor circuit, or microcomputer, e.g. a circuit for digital signal processing (digital signal processor, DSP), a Central Processing Unit (CPU), a processing unit, a processing circuit, a processor, an Application Specific Integrated Circuit (ASIC), a microprocessor, or other processing logic that may interpret and execute instructions. The calculation unit may represent a processing circuitry comprising a plurality of processing circuits, such as, e.g., any, some or all of the ones mentioned above. The control unit 50 may further comprise a memory unit which provides the calculation unit with, for example, stored program code and/or stored data which the calculation unit needs to enable it to do calculations. The calculation unit may also be adapted to storing partial or final results of calculations in the memory unit. The memory unit may comprise a physical device utilised to store data or programs, i.e., sequences of instructions, on a temporary or permanent basis.

The control unit 50 is configured to generate the trigger signal T_{gen} dependent on the air pressure around the centrifuge bowl 10 and to send the generated trigger signal T_{gen} to the OWM 40 The control unit 50 may therefore further comprise an interface for sending instructions to the compressed air unit 42 and for receiving information about the pressure in the surrounding space 3, and also for receiving information about the flow rate of the liquid mixture that is introduced to the inlet 11 and the rotational speed of the rotating centrifuge bowl 10.

The method used to calculate the magnitude of T_{gen} by the control unit 50 is further discussed in relation to FIG. 4 below.

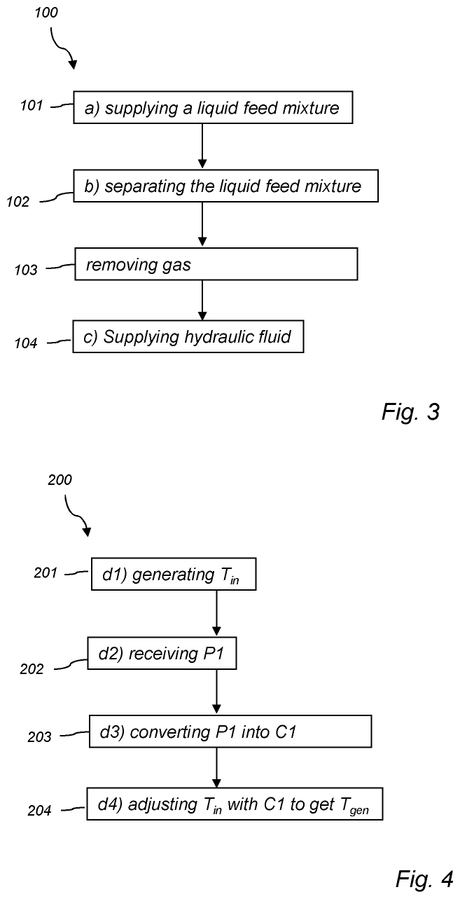

The method 100 of the present invention is further illustrated by the flow chart in FIG. 3.

During operation of the separator in FIGS. 1 and 2, the centrifuge bowl 10 is caused to rotate by torque transmitted from the drive motor 4 to the spindle 7. Gas is pumped out of the surrounding space 3 outside the centrifuge bowl 10 by the vacuum pump 26, thereby maintaining in the surrounding space 3 a pressure of e.g. 1-50 kPa, such as 2-10 kPa. Thus, gas is removed from the surrounding space 3 to obtain a negative pressure in the surrounding space 3.

Via the inlet 11, a liquid mixture to be separated is brought into the separation space 21 within the centrifuge bowl 10 and between the separation discs of the stack 22 fitted in the separation space 21.

A separated liquid light phase moves radially inwards between the separation discs and is discharged via the liquid light phase outlet 12 to the stationary outlet pipe 12a, whereas separated liquid heavy phase is discharged via the liquid heavy phase outlet 13 to the stationary outlet pipe 13a. Heavier components in the liquid mixture, e.g. sludge particles and/or heavy phase, move radially outwards between the separation discs and accumulate at the periphery of the separation space 21 at the sludge outlets 14.

Sludge is emptied intermittently from the sludge outlets 14 by supplying hydraulic fluid to the intermittent discharge system 30 from the OWM 40, whereupon sludge and a certain amount of fluid is discharged from the separation space by means of centrifugal force. The amount of supplied hydraulic fluid is determined by the magnitude of a generated trigger signal T_{gen}, in this case the magnitude of a generated air pressure from compressed air unit 42. The magnitude of T_{gen} is dependent on the air pressure around the centrifuge bowl 10. This is performed by measuring the air pressure around the centrifuge bowl 10 and use the measured air pressure for determining the magnitude of the generated trigger signal.

Thus, as illustrated in FIG. 3, the method 100 of operating the centrifugal separator 1 comprises the steps of
a) supplying 101 a liquid feed mixture to be separated to the inlet 11 of the centrifuge bowl 10,
b) separating 102 the liquid feed mixture into at least one separated liquid phase and a separated sludge phase,
c) supplying hydraulic fluid to the intermittent discharge system 30 to initiate discharge 104 of a separated sludge phase from the centrifuge bowl 10, wherein the amount of supplied hydraulic fluid is determined by the magnitude of a generated trigger signal T_{gen} and further wherein the magnitude of the generated trigger signal T_{gen} is dependent on the air pressure around the centrifuge bowl 10.

The control unit 50 is used for calculating the magnitude of T_{gen}. As illustrated in FIG. 4, this may be performed by a method 200. Consequently, the control unit 50 may be configured to
d1) generating 201 an initial trigger signal Tᵢₙ;
d2) receiving a 202 measured negative air pressure P1 from the space (3) surrounding the centrifuge bowl (10);
d3) converting 203 the measured air pressure P1 into a compensation factor C1 using an equation C(P) of the compensation factor C as a function of the negative air pressure around the centrifuge bowl (10);
d4) adjusting 204 the magnitude of the initial trigger signal Tᵢₙ with the compensation factor C1 to generate the magnitude of the generated trigger signal T_{gen}.

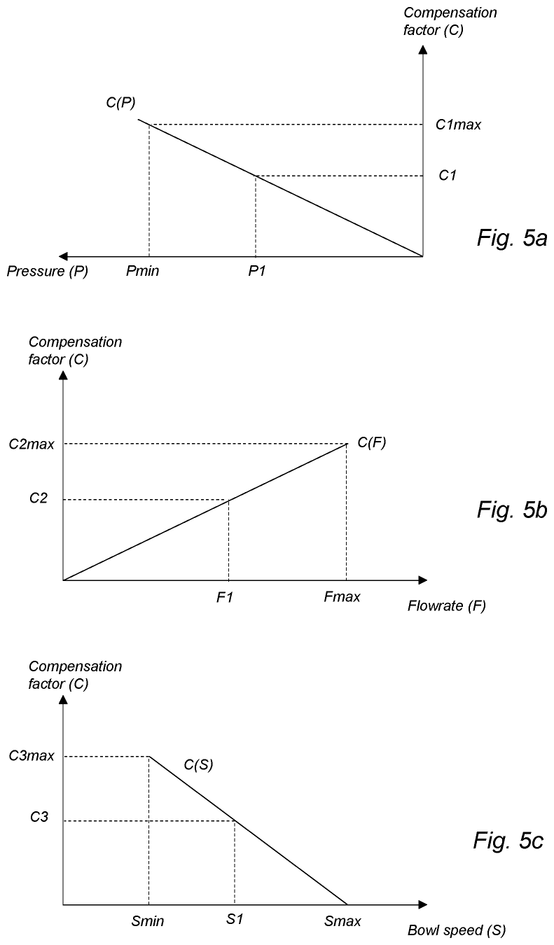

The method 200 is further explained by the FIGS. 5a-5c. The method first comprises a step d1) of generating an initial trigger signal Tᵢₙ. This may be an initial setpoint for the magnitude of the compressed air from the compressed air unit. The magnitude of Tᵢₙ this may be process specific and may be set to a specific value depending on the process, such as the amount of sludge generally found in the liquid mixture to be separated. The magnitude of Tᵢₙ may for example be set by an operator before the separation process, i.e. method 100, is initiated. Tᵢₙ may be set as the percentage of a maximum generated trigger signal Tₘₐₓ. This maximum value may for example correspond to the upper range of an I/P converter used to set the actual air pressure to the OWM 40. The pressure range of the compressed air unit 42 may be between 0-600 kPa, so Tₘₐₓ may correspond to 600 kPa and Tᵢₙ may be used as a percentage or fraction of Tₘₐₓ.

By measurement of the actual negative air pressure P1 around the centrifuge bowl 30, a compensation factor C1 is determined in step d2. P1 may for example be measured continuously or just before initiating discharge. Thus, C1 may be determined dynamically at each sludge discharge. P1 is converted into C1 by using a straight-line relationship, i.e. a function of C(P) of the compensation factor C as a function of the negative air pressure around the centrifuge bowl, as illustrated in FIG. 5a. This straight-line function C(P) may be generated by using a compensation factor of zero at atmospheric pressure (zero negative pressure), i.e. C(0)=0, and a maximum pressure compensation factor C1ₘₐₓ at the lowest possible air pressure around the bowl Pₘᵢₙ, wherein C(Pₘᵢₙ)=C1ₘₐₓ.

When the measured P1 has been converted into a compensation factor C1, the initial trigger signal Tᵢₙ is adjusted by C1 to generate the magnitude of the generated trigger signal T_{gen}, i.e. the magnitude of the compressed air being sent to the pneumatic pump 41 of the OWM. Also the magnitude of the generated trigger signal T_{gen} is defined as the percentage or fraction of a maximum generated trigger signal Tₘₐₓ. As an example, T_{gen} may be set such that T_{gen}=Tᵢₙ−C1.

The magnitude of the generated trigger signal T_{gen} may further be dependent on the flow rate of liquid feed mixture and/or the rotational speed of the centrifuge bowl 10. This means that the method 100 may also comprise measuring the flow rate of liquid feed mixture and/or measuring the speed of the rotational bowl. One or both of these measurements may be performed continuously or at discrete time points.

T_{gen} may be adjusted based on the flow rate of liquid feed mixture and/or the rotational speed of the centrifuge bowl 10 in similar ways as described for the air pressure above. Thus, the control unit may be configured to
d1) generating 201 an initial trigger signal Tᵢₙ;
d2) receiving a 202 measured negative air pressure P1 from the space (3) surrounding the centrifuge bowl (10) and receiving a measured flowrate F1 of the liquid feed mixture and/or a measured rotational speed S1 of the centrifuge bowl 10;
d3) converting 203 the measured air pressure P1 into a compensation factor C1 using an equation C(P) of the compensation factor C as a function of the negative air pressure around the centrifuge bowl (10)
and converting the measured flowrate F1 of the liquid feed mixture into a compensation factor C2 using an equation C(F) of the compensation factor C as a function of the flow rate of the liquid mixture
and/or converting the measured rotational speed S1 into a compensation factor C3 using an equation C(S) of the compensation factor C as a function of the rotational speed;
d4) adjusting 204 the magnitude of the initial trigger signal Tᵢₙ with the compensation factors C1, C2 and/or C3 to generate the magnitude of the generated trigger signal T_{gen}.

C1 C2 and/or C3 may all thus be determined dynamically before each discharge of a sludge phase.

C(F) may be a straight-line function. C(F) may be generated by using a compensation factor of zero at zero flow rate, i.e. C(0)=0, and the maximum pressure compensation factor C2ₘₐₓ as the compensation factor at the highest possible flow rate Fₘₐₓ, wherein C(Fₘₐₓ)=C2ₘₐₓ, as illustrated in FIG. 5b.

C(S) may be a straight-line function. C(S) may be generated by using a maximum compensation factor of C3ₘₐₓ at the lowest allowed operational bowl speed Sₘᵢₙ, i.e. C(Sₘᵢₙ)=C3ₘₐₓ, and a pressure compensation factor of zero at the highest allowed operational bowl speed Sₘₐₓ, wherein C(Sₘₐₓ)=0 as illustrated in FIG. 5c.

The magnitude of T_{gen} may then for example be determined as T_{gen}=Tᵢₙ−C1−C2. C3. This depends on how the straight-line functions have been determined.

The method 100 may of course also comprise a step of supplying hydraulic fluid, such as closing water, to the centrifugal bowl 10 for closing the sludge outlets again, as known in the art.

The invention is not limited to the embodiment disclosed but may be varied and modified within the scope of the claims set out below. The invention is not limited to the orientation of the axis of rotation (X) disclosed in the figures. The term “centrifugal separator” also comprises centrifugal separators with a substantially horizontally oriented axis of rotation. In the above the inventive concept has mainly been described with reference to a limited number of examples. However, as is readily appreciated by a person skilled in the art, other examples than the ones disclosed above are equally possible within the scope of the inventive concept, as defined by the appended claims.

1. A method of operating a centrifugal separator, wherein the centrifugal separator comprises:
a centrifuge bowl arranged to rotate around an axis of rotation and in which the separation of a liquid mixture takes place;
a stationary frame defining a surrounding space in which said centrifuge bowl is arranged; and
a drive member configured to rotate the centrifuge bowl in relation to the stationary frame around the axis of rotation,
wherein the centrifuge bowl further comprises an inlet for receiving the liquid mixture to be separated, at least one liquid outlet for discharging a separated liquid phase and an intermittent discharge system for discharging a separated sludge phase from the centrifuge bowl, and
wherein the method comprises the steps of:
a) supplying a liquid feed mixture to be separated to the inlet of the centrifuge bowl;
b) separating the liquid feed mixture into at least one separated liquid phase and a separated sludge phase; and
c) supplying hydraulic fluid to the intermittent discharge system to initiate discharge of a separated sludge phase from the centrifuge bowl,
wherein an amount of supplied hydraulic fluid is determined by a magnitude of a generated trigger signal T_{gen}; and
wherein the magnitude of the generated trigger signal T_{gen} is dependent on air pressure around the centrifuge bowl.

2. The method according to claim 1, wherein the method further comprises removing gas from the surrounding space to obtain a negative pressure in the surrounding space.

3. The method according to claim 1, wherein the method further comprises measuring the air pressure around the centrifuge bowl and using the measured air pressure for determining the magnitude of the generated trigger signal.

4. The method according to claim 1, wherein the generated trigger signal T_{gen} is a pneumatic signal.

5. The method according to claim 1, wherein the hydraulic fluid in step c) is water that is supplied to the intermittent discharge system by an operating water module.

6. The method according to claim 1, wherein the magnitude of the generated trigger signal T_{gen} is generated by performing the steps of
d1) generating an initial trigger signal Tᵢₙ;
d2) receiving a measured negative air pressure P1 from the space surrounding the centrifuge bowl;
d3) converting the measured air pressure P1 into a compensation factor C1 using an equation C(P) of the compensation factor C as a function of the negative air pressure around the centrifuge bowl; and
d4) adjusting the magnitude of the initial trigger signal Tᵢₙ with the compensation factor C1 to generate the magnitude of the generated trigger signal T_{gen}.

7. The method according to claim 6, wherein the C(P) equation is a straight-line equation.

8. The method according to claim 7, wherein the C(P) equation has been determined using a calibration procedure using a maximum pressure compensation factor Cₘₐₓ at a lowest possible air pressure Pₘₐₓ, wherein Cₘₐₓ=C(Pₘₐₓ).

9. The method according to claim 6, wherein the magnitude of the initial trigger signal Tᵢₙ is defined by a specific separation process or an operator before operation of the centrifugal separator.

10. The method according to claim 6, wherein the magnitude of the generated trigger signal T_{gen} is defined as a percentage or fraction of a maximum generated trigger signal Tₘₐₓ.

11. The method according to claim 1, wherein the magnitude of the generated trigger signal is further dependent on a rotational speed of the centrifuge bowl and/or a flow rate of liquid feed mixture.

12. The method according to claim 11, wherein the method further comprises measuring the flow rate of liquid feed mixture and/or measuring the rotational speed of the centrifuge bowl.

13. A centrifugal separator for separating at least one liquid phase and a sludge phase from a liquid feed mixture, comprising:
a centrifuge bowl arranged to rotate around an axis of rotation and in which the separation of the liquid feed mixture takes place, place;
a stationary frame defining a surrounding space in which said centrifuge bowl is arranged;
a drive member configured to rotate the centrifuge bowl in relation to the stationary frame around the axis of rotation, wherein the centrifuge bowl further comprises an inlet for receiving the liquid mixture to be separated, and at least one liquid outlet for discharging a separated liquid phase;
an intermittent discharge system for discharging a separated sludge phase from the centrifuge bowl;
a supply system for supplying hydraulic fluid to the intermittent discharge system, wherein an amount of supplied hydraulic fluid is determined by a magnitude of a generated trigger signal T_{gen}; and
controller configured to generate said trigger signal T_{gen} dependent on air pressure around the centrifuge bowl and to send said generated trigger signal T_{gen} to said supply system.

14. The centrifugal separator according to claim 13, wherein the centrifugal separator further comprises a pump device arranged for removing gas to obtain sub-atmospheric pressure in said surrounding space.

15. The centrifugal separator according to claim 13, wherein the supply system is an operating water module arranged for supplying water to the intermittent discharge system.

16. The method according to claim 2, wherein the method further comprises measuring the air pressure around the centrifuge bowl and using the measured air pressure for determining the magnitude of the generated trigger signal.

17. The method according to claim 2, wherein the generated trigger signal T_{gen} is a pneumatic signal.

18. The method according to claim 3, wherein the generated trigger signal T_{gen} is a pneumatic signal.

19. The method according to claim 2, wherein the hydraulic fluid in step c) is water that is supplied to the intermittent discharge system by an operating water module.

20. The method according to claim 3, wherein the hydraulic fluid in step c) is water that is supplied to the intermittent discharge system by an operating water module.
